(19) United States
(12) Patent Application Publication
(10) Pub. No.: US 2005/0086013 A1
(43) Pub. Date: Apr. 21, 2005

(54) Analysis of ultrasonic reflections to measure distance

(76) Inventors: Philip R. Couch, Honiton (GB); Alexander M. Barry, Winterville, NC (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/934,348

(22) Filed: Sep. 3, 2004

Related U.S. Application Data
(60) Provisional application No. 60/499,722, filed on Sep. 4, 2003.

(51) Int. Cl. G01F 17/00; G01F 23/00; G01B 11/14

(52) U.S. Cl. 702/55; 702/158

(57) ABSTRACT

A distance measurement device includes an ultrasonic transmitter adapted to emit ultrasonic energy toward an object and a receiver positioned to receive a signal reflected from the object. The device also includes a controller that is programmed to analyze the signal. The controller includes a signal conditioner adapted to produce an output signal proportional to a logarithm of the reflected signal, a sampler adapted to periodically sample the output signal into a plurality of samples arranged time-wise, and an analyzer adapted to identify a peak sample from the plurality of samples. The peak sample has the greatest magnitude of the plurality of samples. The analyzer is further adapted to thereafter identify an intermediate sample having a magnitude approximately equal to a predetermined fraction of the magnitude of the peak sample and use the intermediate sample to determine a distance between the device and the object.

### CROSS-REFERENCES TO RELATED APPLICATIONS

This application is a non-provisional of, and claims the benefit of, co-pending U.S. Provisional Application No. 60/499,722, entitled “ANALYSIS OF ULTRASONIC REFLECTIONS TO MEASURE DISTANCE,” filed on Sep. 4, 2003, by Philip R. Couch, et al., the entire disclosure of which is herein incorporated by reference for all purposes.

### BACKGROUND OF THE INVENTION

Embodiments of the present invention relate generally to measurement devices. More specifically, embodiments of the invention relate to ultrasonic measurement devices and particular methods of analyzing signals produced there from.

Distances to surfaces may be measured by bouncing a short burst of ultrasonic energy and measuring the time-of-flight of the returned burst. An ultrasonic transducer is typically driven with a large amplitude burst in order to transmit the energy then the same transducer is used to receive the reflected energy. The output is amplified to an easily detectable level and the position of the reflection (in time) is noted from which the distance is calculated.

Measuring the presence of the reflected energy is most easily done by noting when the energy exceeds some predetermined threshold. Because, however, the energy returned from a surface depends on a number of factors, the energy may only slightly exceed the threshold or may greatly exceed the threshold. As a result, devices configured to detect a constant threshold will tend to detect the first case late and the second case earlier causing an error in the measurement. Embodiments of the invention address these and other limitations.

### BRIEF SUMMARY OF THE INVENTION

Embodiments of the invention thus provide a distance measurement device. The device includes an ultrasonic transmitter adapted to emit ultrasonic energy toward an object and a receiver positioned to receive a signal reflected from the object. The device also includes a controller that is programmed to analyze the signal. The controller includes a signal conditioner adapted to produce an output signal proportional to a logarithm of the reflected signal, a sampler adapted to periodically sample the output signal into a plurality of samples arranged time-wise, and an analyzer adapted to identify a peak sample from the plurality of samples. The peak sample has the greatest magnitude of the plurality of samples. The analyzer is further adapted to thereafter identify an intermediate sample having a magnitude approximately equal to a predetermined fraction of the magnitude of the peak sample and use the intermediate sample to determine a distance between the device and the object.

In some embodiments of the distance measuring device, the object comprises a fluid surface. The predetermined fraction may be half the peak sample.

In still other embodiments, a method of measuring distance includes emitting ultrasonic energy toward an object, receiving a signal comprising ultrasonic energy reflected from the object, using the signal to create a second signal that is proportional to a logarithm of the reflected signal, sampling the second signal to thereby produce a sequence of samples, identifying a peak sample from the plurality of samples, and searching the sequence of samples to identify a second sample having a magnitude approximately equal to a predetermined fraction of the peak sample. The second sample represents a point in time prior to a point in time of the peak sample. The method also includes using time domain information related to the second sample to determine a distance to the object. The object may be a fluid surface. The predetermined fraction may be half the peak sample.

In further embodiments, a fluid level measurement device includes means for emitting ultrasonic energy directed toward a surface of a fluid, means for receiving a signal reflected from the fluid, and means for analyzing the signal by creating a processed signal proportional to the logarithm of the reflected signal, sampling the processed signal into a plurality of samples arranged consecutively time-wise, identifying a peak sample, and identifying a half-peak sample having approximately half the magnitude of the peak sample. The half-peak sample occurs prior than the peak sample in the plurality of samples. Analyzing also includes using the half-peak sample to determine a time-of-flight for the ultrasonic energy from the emitting means to the receiving means and using the time-of-flight to quantify a characteristic relating to the liquid. The characteristic may be a distance from the emitting means to the surface of the fluid. The characteristic may be a volume of fluid.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an ultrasonic distance measuring device according to embodiments of the invention.

FIG. 2 illustrates an exemplary analysis circuit according to embodiments of the invention, which circuit may be employed in the device of FIG. 1.

FIG. 3 illustrates a method of using a distance measuring device, such as the device of FIG. 1.

### DETAILED DESCRIPTION OF THE INVENTION

According to embodiments of the invention, electrical signals received at an ultrasonic transducer, having been reflected from a distant surface, are amplified and processed digitally to accurately determine the reflector distance regardless of reflected amplitude. In some embodiments, this comprises locating a peak in the reflected signal, then working backward, time-wise, through consecutive prior samples to locate a sample that represents a fraction of the peak.

In some embodiments, the amplifier used to amplify the received signal has a logarithmic amplitude response, rather than the conventional linear response. The signal is rectified, sampled and digitized. The samples are analyzed as they are received to find the first significant peak using a state machine. In the initial state the samples are ignored when they are below a fixed threshold, roughly corresponding to the background noise level plus remaining noise from the transmit burst, thus avoiding false triggering on these signals. When a rising level is detected the state machine moves to the second state where it searches for a point where the level is falling again. This means the peak has been just passed. The previous few samples are then parsed to find the point where the signal was at the half-height level. Because the signal was logarithmically scaled this becomes a simple process of looking for a level a fixed voltage below the peak voltage, as logarithmic division simply involves subtraction of the logarithmic values. Thereby a detection system is achieved with wide dynamic range and simple but accurate processing that may be accomplished with minimum cost and power consumption.

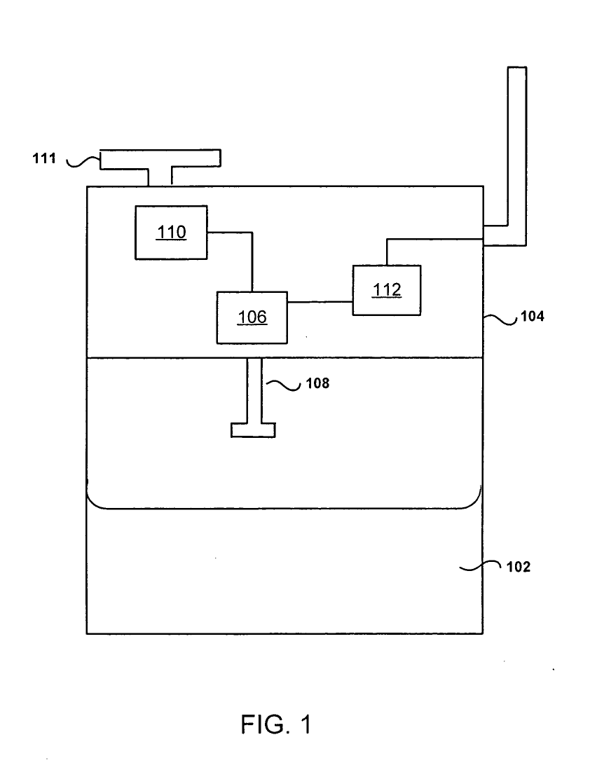

Having described embodiments of the invention generally, attention is directed to FIG. 1, which illustrates an exemplary fluid level measurement device 100 according to an embodiment of the invention. In this embodiment, the device 100 is configured to use ultrasound to measure the level of a material 102 in a tank 104. The material 102 may be practically any material capable of reflecting ultrasonic energy. The device 100 includes a controller 106, a transducer/receiver 108, a power supply 110, and a transmitter/receiver 112. Those skilled in the art will appreciate that the device 100 is merely exemplary and other embodiments according to the invention may not include all the components illustrated and described here. Still other embodiments may include different or additional components.

The controller 106 may be any of a variety of devices programmed to operate according to the teachings herein. The controller 106 causes the transducer/receiver 108 to emit ultrasonic energy that travels from the transducer/receiver 108 to the material 102. The transducer/receiver 108 then “listens” for the reflection of the ultrasonic energy. The reflected waveform is then analyzed by the controller 106 to determine the time of travel of the ultrasonic pulse, which is then used to measure the height of the material 102 in the tank 104.

The power supply 110 may include solar power cells, batteries, and the like. The transmitter/receiver 112 periodically may send measurement information to a central monitoring location or may respond upon interrogation. Those skilled in the art will appreciate that any of a number of suitable power supplies and transmitter/receivers may be used according to embodiments of the invention.

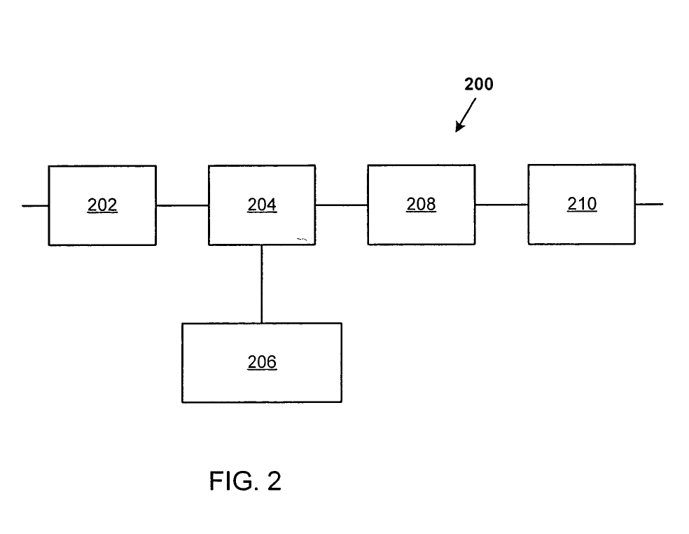

The controller 106 also may include analysis circuitry to determine the point in a reflected signal that best approximates the material level in the tank. FIG. 2 illustrates an exemplary analysis circuit 200 according to embodiments of the invention. The reflected signal received by the transducer/receiver 108 is first passed through a signal conditioning circuit 202. The signal conditioning circuit 202 may include amplifiers, rectifiers, filters, and the like, that function to prepare the signal for sampling. In a specific embodiment, the signal conditioning circuit 202 includes a logarithmic amplifier that produces an output signal that is proportional to the logarithm of the input signal. The output of the signal conditioning circuit 202 is then fed to a sampling circuit 204 that samples the signal at a frequency determined by a sample frequency generator 206. The sample frequency is selected so as to provide appropriate resolution for determining the time of travel of the signal. Once sampled, the analog result is digitized by an analog-to-digital converter 208. The samples are then sent to a state analysis device 210 for analysis.

The state analysis device 210 may be any of a number of well known devices. It may include, for example, a buffer that stores a predetermined number of samples plus comparative circuitry for evaluating differences between samples. In this specific embodiment, the state analysis device 210 is programmed to determine the specific sample that most closely approximates the material level by locating the sample at the midpoint of the rising pulse. It does this by first comparing individual samples in the incoming sample stream and locating the peak sample. Once the peak sample is located, the state analysis device 210 then looks back over the preceding sequence of samples to find the sample closest in magnitude to half the peak sample magnitude. This sample is then selected to represent the level of the material in the tank, and the round-trip travel time from the transducer receiver 108 to the material 102 and back is used to calculate the distance from the device to the material level.

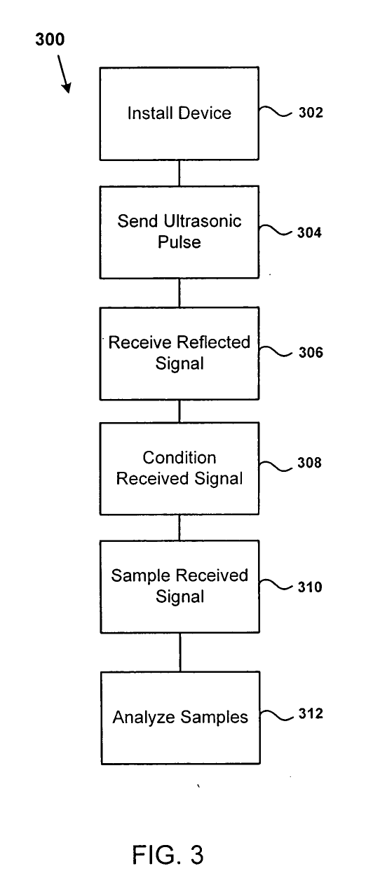

FIG. 3 illustrates a method 300 according to embodiments of the invention. The method 300 is merely exemplary, and those skilled in the art will appreciate that methods according to other embodiments may include more, fewer, or different steps than those illustrated here. The method 300 begins at block 302, at which point a fluid level measurement device according to embodiments of the invention is installed on a tank, silo, or other vessel in which a material may be contained. Installation includes attaching the device, calibrating it, and testing it. In some embodiments, measurements are relative, in which case installation includes determining the factors needed to convert relative measurements to absolute measurements such as the location of the device relative to the base or bottom of the vessel, the total volume of material the vessel will hold, and the like.

At block 304, a measurement is initiated by sending an ultrasonic pulse from the transducer to the material. The measurement may be initiated by the controller and may take place following the passage of a predetermined amount of time, may be initiated in response to a predetermined scheduled sample, and/or may be initiated in response to an interrogation from an external device requesting a measurement to be taken. Other examples are possible.

At block 306, the reflected signal is received by a receiver and is conditioned at block 308. Signal conditioning may include converting the signal to a logarithmic response. Because the amplitude of the received signal may vary over a wide range depending on the distance to the material and reflection efficiency of the surface of the material, it may be difficult to retain linearity of this large signal range. Thus, converting the signal to a logarithm of the initial signal provides greater accuracy in some embodiments and applications.

At block 310, the conditioned signal is sampled and converted to a sequence of digital samples, which are stored for analysis. The samples are analyzed at block 312.

Analyzing the samples may comprise first locating a peak sample, having the higher amplitude from among the sequence of samples. Thereafter, working backward in time from the peak sample, a sample having a value nearest in magnitude to a predetermined fraction of the peak sample is located. This sample is determined to represent the point in time at which the ultrasonic energy reflected from the surface of the material was received at the measurement device. The round trip time, therefore, may be used to determine the distance to the material or the depth of the material in the vessel.

The predetermined fraction may be determined by trial and error and may depend on the material. In a specific example, the predetermined fraction is half the peak sample.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. For example, those skilled in the art know how to manufacture and assemble electrical devices and components. Accordingly, the above description should not be taken as limiting the scope of the invention, which is defined in the following claims.

1. A distance measurement device, comprising:
an ultrasonic transmitter adapted to emit ultrasonic energy toward an object;
a receiver positioned to receive a signal reflected from the object;
a controller programmed to analyze the signal, the controller having:
a signal conditioner adapted to produce an output signal proportional to a logarithm of the reflected signal;
a sampler adapted to periodically sample the output signal into a plurality of samples arranged time-wise; and
an analyzer adapted to:
identify a peak sample from the plurality of samples, the peak sample having the greatest magnitude of the plurality of samples;
thereafter identify an intermediate sample having a magnitude approximately equal to a predetermined fraction of the magnitude of the peak sample; and
use the intermediate sample to determine a distance between the device and the object.

2. The distance measuring device of claim 1, wherein the object comprises a fluid surface.

3. The distance measuring device of claim 1, wherein the predetermined fraction comprises half the peak sample.

4. A method of measuring distance, comprising:
emitting ultrasonic energy toward an object;
receiving a signal comprising ultrasonic energy reflected from the object;
using the signal to create a second signal that is proportional to a logarithm of the reflected signal;
sampling the second signal to thereby produce a sequence of samples;
identifying a peak sample from the plurality of samples;
searching the sequence of samples to identify a second sample having a magnitude approximately equal to a predetermined fraction of the peak sample, wherein the second sample represents a point in time prior to a point in time of the peak sample; and
using time domain information related to the second sample to determine a distance to the object.

5. The method of claim 4, wherein the object comprises a fluid surface.

6. The method of claim 4, wherein the predetermined fraction comprises half the peak sample.

7. A fluid level measurement device, comprising:
means for emitting ultrasonic energy directed toward a surface of a fluid;
means for receiving a signal reflected from the fluid;
means for analyzing the signal by:
creating a processed signal proportional to the logarithm of the reflected signal;
sampling the processed signal into a plurality of samples arranged consecutively time-wise;
identifying a peak sample;
identifying a half-peak sample having approximately half the magnitude of the peak sample, wherein the half-peak sample occurs prior than the peak sample in the plurality of samples;
using the half-peak sample to determine a time-of-flight for the ultrasonic energy from the emitting means to the receiving means; and
using the time-of-flight to quantify a characteristic relating to the liquid.

8. The device of claim 7, wherein the characteristic comprises a distance from the emitting means to the surface of the fluid.

9. The device of claim 7, wherein the characteristic comprises a volume of fluid.
